(19) United States
(12) Patent Application Publication
(10) Pub. No.: US 2006/0146195 A1
(43) Pub. Date: Jul. 6, 2006

(54) Method and apparatus for preventing contents from being recorded by external device

(75) Inventor: Sang-Hyeon Yoon, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/297,713

(22) Filed: Dec. 8, 2005

(30) Foreign Application Priority Data
Dec. 8, 2004 (KR) 2004-103055

(51) Int. Cl. H04N 9/74

(52) U.S. Cl. 348/587

(57) ABSTRACT

Disclosed are a method and an apparatus for preventing contents from being recorded by an external device. A digital broadcasting receiver capable of reproducing a broadcasting transmits a watermark together with broadcasting data, thereby preventing unauthorized copying. If contents transmitted by a broadcasting provider are displayed through an external monitor such as a general TV in the case of digital multimedia broadcasting (DMB), the copying of the contents may be performed without any restrictions. Accordingly, in view of content protection mechanism, a unique code is produced only when the DMB data is transmitted to an external device, the digital broadcasting receiver and the DMB data can be traced.

### PRIORITY

This application claims priority under 35 U.S.C. §119 to an application entitled “Method And Apparatus For Preventing Contents From being Recorded By External Device” filed in the Korean Intellectual Property Office on Dec. 8, 2004 and assigned Serial No. 2004-103055, the contents of which are incorporated herein by reference.

### BACKGROUND OF THE INVENTION

1. Field of the Invention

The present invention relates to an apparatus and a method for protecting contents in a digital broadcasting receiver, and more particularly to an apparatus and a method for preventing contents from being recorded by an external device.

2. Description of the Related Art

In order to prevent video media from being copied a Macrovision™ scheme can be utilized. According to the Macrovision scheme, a color burst signal is controlled by reversely using an auto gain control (AGC) function of a device copying the video media so that the copied video cannot be normally displayed. However, when using the Macrovision scheme, a broadcasting transmitter must transmit broadcasting data including a Macrovision signal, and a mobile communication terminal must have a function capable of processing the received Macrovision signal.

In addition to the Macrovision scheme, a variety of other techniques to provide for the protection of digital content have been proposed and/or developed. For example, a Content Protection For Recordable Media (CPRM) technique and a Digital Rights Management (DRM) technique are widely used for providing content protection to digital content. The DRM technique allows a user to purchase a license for the use of coded content and allows a user to decode and reproduce the coded content using the license. The DRM technique provides software for copyright and license security in addition to a payment function and an account settlement function.

For example, in the case of digital multimedia broadcasting (DMB), since a DMB service system typically provides DMB data using a formatted file without coding of the DMB data, a mobile communication terminal can only reproduce recorded digital broadcasting and cannot output the recorded data to an external device according to the requirement of DMB providers, thereby preventing unauthorized copying of the data. In other words, if the mobile communication terminal is designed such that software and hardware thereof do not include functions adaptable for aiding unauthorized copying, it is possible to prevent (and/or reduce) the unauthorized copying of the data stored in the mobile communication terminal.

However, in consideration of the size of a display module of the mobile communication terminal, if the reproduction of the DMB data through an external device is restricted, a user may be inconvenienced.

In contrast, if the CPRM technique or the DRM technique is used in order to prevent unauthorized copying of the DMB data while allowing the reproduction of DMB data through the external device, a mobile communication terminal as well as a digital broadcasting data server must be compatible with the corresponding technique, which can increase manufacturing costs. Moreover, royalties on the CPRM and/or the DRM techniques use should be paid.

### SUMMARY OF THE INVENTION

Accordingly, the present invention has been made to solve the above-mentioned problems occurring in the prior art, and the present invention provides an apparatus and a method capable of economically preventing the record of contents into an external device in a simple structure of a digital broadcasting receiver.

According to a first aspect of the present invention, there is provided an apparatus for preventing contents from being recorded by an external device in a digital broadcasting receiver, the apparatus including a code generator for generating an identification code capable of identifying the digital broadcasting receiver, an output port for outputting received digital broadcasting data to the external device, and a processor for controlling the identification code to be output together with the digital broadcasting data when the digital broadcasting data is output to the external device through the output port.

According to a second aspect of the present invention, there is provided a method for preventing contents from being recorded by an external device in a digital broadcasting receiver capable of connecting with the external device, the method including determining a connection state with the external device, synthesizing a video signal of received digital broadcasting with an identification code for identifying the digital broadcasting receiver, if detecting that the connection with the external device is achieved, and outputting thereafter the synthetic signal to the external device.

According to a third aspect of the present invention, there is provided a method for preventing contents from being recorded by an external device in a digital broadcasting receiver capable of connecting with the external device, the method including determining whether an internal display mode is set or an external display mode is set, synthesizing a video signal of received digital broadcasting with an identification code for identifying the digital broadcasting receiver when detecting that the external display mode is set, and outputting the synthetic signal to the external device.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the structure of a mobile communication terminal for receiving digital broadcasting according to a preferred embodiment of the present invention;

FIG. 2 is a screen shot illustrating an image state in a case where the image is reproduced through a display module of the mobile communication terminal for receiving digital broadcasting according to a preferred embodiment of the present invention;

FIG. 3 is a screen shot illustrating an image state in a case where the image is reproduced through an external device connected to the mobile communication terminal for receiving digital broadcasting according to a preferred embodiment of the present invention;

FIG. 4 is a flowchart illustrating a procedure in which a multimedia processor of a mobile communication terminal for receiving digital broadcasting according to a preferred embodiment of the present invention controls generation of an identification code; and

FIG. 5 is a block diagram illustrating another structure of a mobile communication terminal for receiving digital broadcasting according to a preferred embodiment of the present invention.

### DETAILED DESCRIPTION OF THE PREFERRED EMBODIMENT

Hereinafter, a preferred embodiment of the present invention will be described in detail with reference to the accompanying drawings. The same or similar components in drawings are designated by the same reference numerals as far as possible although they are shown in different drawings. Also, hereinafter, specific items such as specific code values will be given. However, these specific items will be given only in order to understand the present invention. Therefore, it is generally known to those skilled in the art that the present invention can be realized without such specific items. In the following description of the present invention, a detailed description of known functions and configurations incorporated herein will be omitted when it may make the subject matter of the present invention unclear.

The present invention is adaptable for any mobile communication terminal capable of receiving and reproducing digital broadcasting. Therefore, the mobile communication terminal can include a dedicated digital multimedia broadcasting (DMB) receiving mobile communication terminal, a portable phone, a personal data assistant (PDA) device, an MP3 terminal and a Telemetics terminal. Hereinafter, the dedicated DMB receiving mobile communication terminal and the portable phone will be shown and described by way of detailed example according to embodiments of the present invention.

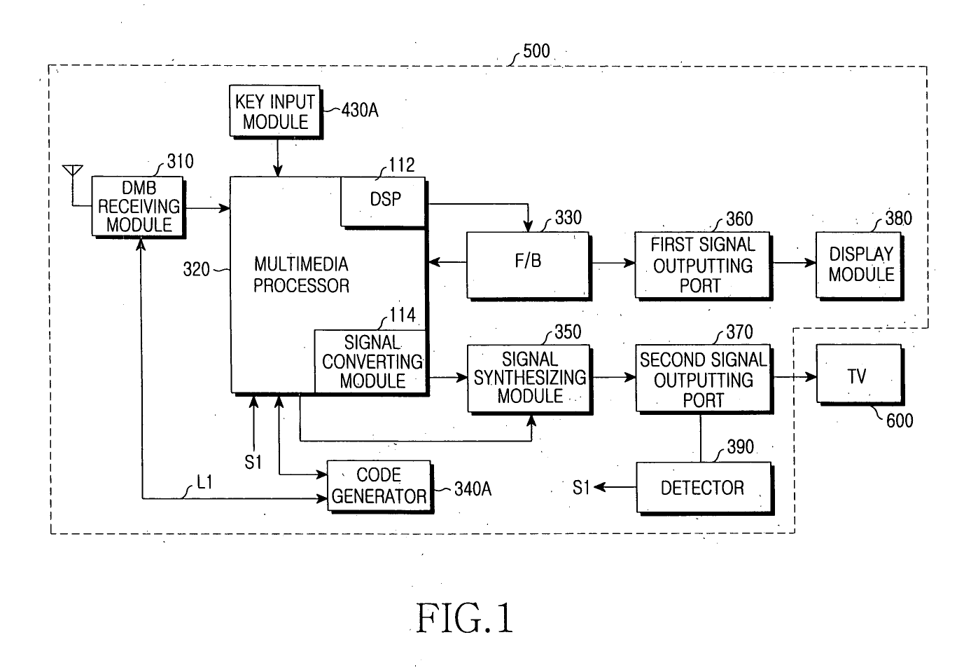

FIG. 1 is a block diagram illustrating the structure of a mobile communication terminal for receiving digital broadcasting according to a preferred embodiment of the present invention.

Reference numeral 500 indicates the DMB receiving mobile communication terminal, and reference numeral 600 indicates a television (TV) which is an example of an external device.

A DMB receiving module 310 receives a compressed broadcasting signal transmitted from a server (not shown) and performs a series of signal processing with respect to the compressed broadcasting signal.

The mobile communication terminal has two signal output ports used to output a video signal (corresponding to digital multimedia broadcast data) such that a user can view the digital multimedia broadcasting. A first signal output port 360 connected to a display module 380 and a second signal output port 370 may be connected to an external device such as a television, a video tape recorder, an optical storage unit, etc. The display module 380 may be realized using a liquid crystal display (LCD) such as the mobile communication terminal's own display module.

If the second signal output port 370 is connected to an external device (e.g., TV 600), the detector 390 detects the connection and generates an external output control signal S1 in order to inform a multimedia processor 320 of the connection.

The multimedia processor 320 divides signals transmitted from the DMB receiving module 310 into a video signal and an audio signal and decompresses the video signal and the audio signal. The decompression process may be performed in the multimedia processor 320, in a digital signal processor (DSP) 112 embedded in the multimedia processor 320, or in an external DSP (not shown).

A frame buffer (F/B) 330 performs buffering for each frame such that the decompressed video signal can be output for visualization.

Data in the frame buffer 330 is transmitted to the display module 380 through the first signal output port 360.

In addition, the data in the frame buffer 330 is delivered to a signal converting module 114, and the format of the data is converted. The format conversion is performed such that the data output from the frame buffer 330 can be displayed on the external device. In detail, if the display resolution through the display module 380 is 320×240 pixels and a display resolution through the TV 600 is 720×480 pixels, a data format conversion is required to convert the output data to the correct display resolution. Thus, data is converted in such a manner so that the data output through the second output port 370 can be used by the external device (e.g., TV 600).

After receiving a code provision request from the multimedia processor 320, a code generator 340A generates codes and provides the generated code to the multimedia processor 320. The code must be an identification code capable of identifying a mobile communication terminal.

Since every smart card has a serial number (i.e., subscriber number), a mobile communication terminal (e.g., a GSM based portable phone) using the smart card used for subscriber authentication uses the serial number as it is or can alternatively generate a unique number by using the serial number and Hash function. In the shown embodiment, it is assumed that the code generator 340A is realized using a smart card.

Satellite DMB supports a certificated access system (CAS) function which is used for de-scrambling a scrambled signal. The smart card may store key values (e.g., CAS code used for scrambling a signal in a broadcasting center, which can be changed at predetermined intervals) necessary for de-scrambling the scrambled signal. Reference numeral L1 represents a path through which the key necessary for the de-scrambling is requested and received between the DMB receiving module 310 and the code generator 340A. As shown in FIG. 1, the DMB receiving module 310 requests a key necessary for the de-scrambling from the code generator 340A, and the code generator 340A provides the DMB receiving module 310 a key generated by the code generator 340A. CAS codes are stored in the smart card. A method for retrieving a desired CAS code can include receiving an index corresponding to a scrambled signal, performing a lookup of the index in a table and retrieving a CAS code corresponding to the index from the table. The index can be transmitted using a channel which is different from the channel through which scrambled signal is transmitted. After retrieving the desired CAS code, the scrambled signal can be descrambled using the CAS code and output as desired (e.g., to appropriate video and audio devices).

A signal synthesizing module 350 synthesizes a signal output from the signal converting module 114 with an identification code delivered from the multimedia processor 320 and delivers the synthesized result to the second signal outputting port 370.

As described above, the multimedia processor 320 may determine a generation state of an identification code in response to user's input instead of the detector 390. In other words, on an assumption that the user performs input for setting an internal display mode when the user desires to display DMB data through the display module 380 and performs input for setting an external display mode when the user desires to display DMB data through the TV 600, the code generator 340A is controlled in such a manner that the code generator 340A generates the identification code or does not generate the identification code according to the user's input.

Although the mobile communication terminal according to the present invention further includes a generally-known memory module (e.g., typically a Read-Only Memory (ROM), Random Access Memory (RAM), etc.), a microphone and a speaker in addition to the above described components, these and other components are neither shown or described in FIG. 1 for the sake of clarity

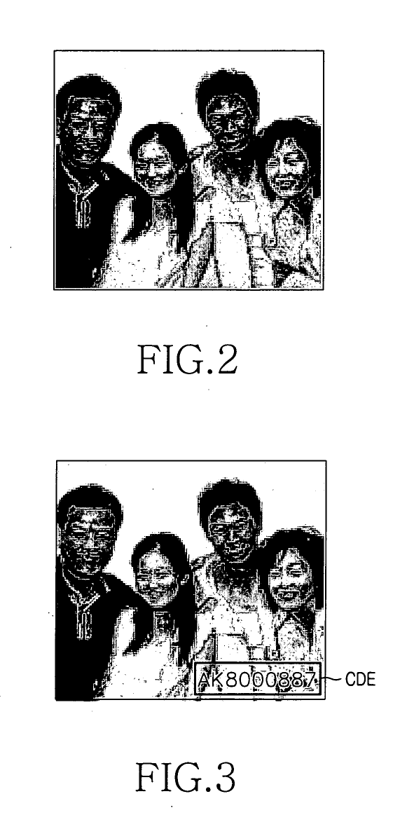

FIG. 2 illustrates an image state in a case where the image is reproduced through the display module embedded in the DMB receiving mobile communication terminal according to a preferred embodiment of the present invention.

The image on the display module 380 shown in FIG. 1 shows DMB broadcasting transmitted from a servers. In other words, the image does not include a code capable of identifying a mobile communication terminal as illustrated in the image shown in FIG. 3.

FIG. 3 illustrates an image state in a case where the image is reproduced through an external device connected to the mobile communication terminal for receiving digital broadcasting according to a preferred embodiment of the present invention.

In other words, FIG. 3 illustrates the state of the image displayed on an external display device such as the TV 600 shown in FIG. 1. For example, a code of “AK8000887” is displayed with video data as indicated by reference numeral CDE. This code of “AK8000887”, which is an identification code capable of identifying a mobile communication terminal, is used for preventing unauthorized copying. In addition, since the code of the “AK8000887” is used for identifying a mobile communication terminal, even when the video is copied, a corresponding mobile communication terminal can be traced by the code of the “AK8000887 shown when the copied video is reproduced. Accordingly, an unauthorized copying can be prevented in advance.

As described above, when a received broadcasting signal is displayed through an external device, specific marking is shown. In contrast, when the display module embedded in the mobile communication terminal is used, such marking is not shown, so that the user is not visually inconvenienced.

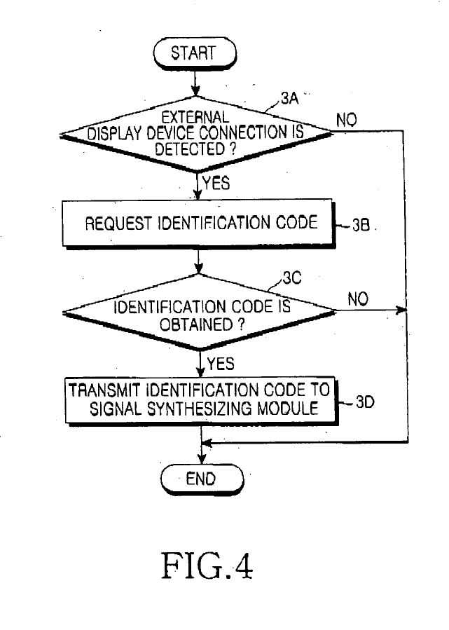

FIG. 4 is a flowchart illustrating a procedure in which the multimedia processor 320 of the mobile communication terminal for receiving digital broadcasting according to a preferred embodiment of the present invention controls the generation of an identification code.

The multimedia processor 320 determines if the mobile communication terminal is connected to an external device (e.g., the TV 600) in step 3A. The determination of the connection state may be achieved through the determination of the detector 390 for a generation state of an external output control signal S1. Although it is not shown, the determination of the connection state may be achieved through the determination of the type of an input mode (e.g., an internal display mode or an external display mode) set by the user. In addition, the determination of the connection state may be achieved through both the determination of the detector 390 and the determination of the type of the input mode.

If it is determined that the mobile communication terminal is connected to the external device, the multimedia processor 320 requests an identification code from the code generator 340A in step 3B. If it is determined that the identification code is obtained from the code generator 340A in step 3C, the obtained identification code is provided to the signal synthesizing module 350 in step 3D.

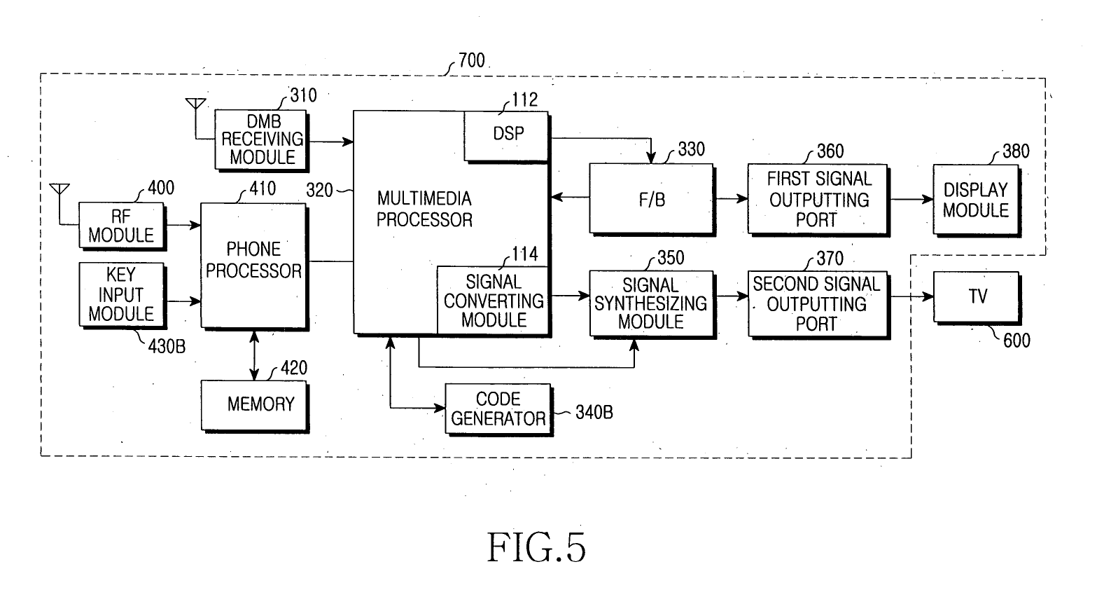

FIG. 5 is a block diagram illustrating another structure of a mobile communication terminal for receiving digital broadcasting according to a preferred embodiment of the present invention.

Reference numeral 700 represents a DMB receiving portable phone, and reference numeral 600 represents a TV which is an example of an external device. A radio frequency (RF) module 400 transmits/receives signals relating to communication.

A phone processor 410 may be realized using a QualComm mobile station modem (MSM) 5500 and controls the operation of a mobile communication terminal including a portable phone function.

A memory 420 stores reference data required for generating a identification code, such as a mobile identification number (MIN) and an electronic serial number (ESN). The memory 420 may be realized using, for example, a NAND flash memory.

Remaining components perform the same operation as the components shown in FIG. 1 and are therefore not described for the sake of clarity. However, it is assumed that the mobile communication terminal for receiving digital broadcasting shown in FIG. 5 processes terrestrial DMB and does not require the use of a smart card while the above described mobile communication terminal for receiving digital broadcasting shown in FIG. 1 requires a CAS function for receiving satellite DMB, so that a CAS delivery path (reference numeral L1) is not required between the multimedia processor 320 and a code generator 340B.

The multimedia processor 320 receives the MIN or the ESN from the phone processor 410 to be provided to the code generator 340B, and the code generator 340B generates an identification code based on the MIN or the ESN.

The shown structures are only exemplary embodiments, and the structures may be changed in actual embodiments. For example, key input data output from a key input module 430B may be directly input to the multimedia processor 320 without passing through the phone processor 410. In addition, if necessity, the structures may be realized in such a manner that the key input data are delivered to the phone processor 410. Furthermore, the phone processor 410 and the multimedia processor 320 may be realized in a single chip.

In addition, although the phone function is described by employing voice communication as an example, it is natural that the phone function can perform data communication by transmitting/receiving packet data and/or video data.

As described above, according to the present invention, unique identification code for a corresponding mobile communication terminal is generated, and this serial code (e.g., CDE in FIG. 3 is synthesized with contents output to an external device, thereby preventing unauthorized copying. In other words, if contents such as DMB received in the mobile communication terminal are copied to an external device, the unique identification code is copied together with the contents, so that it is easy to trace the mobile communication terminal. Accordingly, unauthorized copying can be prevented. In addition, since it is unnecessary to transmit specific broadcasting and additional hardware is not required in order to prevent the unauthorized copying, and since the mobile communication terminal can prevent the unauthorized copying itself, copy protection may be efficiently performed. In addition, it is useful to selectively employ copy protection only for specific broadcasting (special contents requiring copy protection) types. However, in this case, it is premised that the mobile communication terminal recognizes the type of the broadcasting.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. An apparatus for preventing contents from being recorded by an external device in a digital broadcasting receiver, the apparatus comprising:
a code generator for generating an identification code capable of identifying the digital broadcasting receiver;
an output port for outputting received digital broadcasting data to the external device; and
a processor for controlling the identification code to be output together with the digital broadcasting data, if the digital broadcasting data is output to the external device through the output port.

2. The apparatus as claimed in claim 1, further comprising a detector detecting a connection between the output port and the external device and generating an external output control signal, if the output port is connected to the external device,
wherein the processor controls the output of the identification code in response to the external output control signal.

3. The apparatus as claimed in claim 1, further comprising a synthesis module for producing a video signal to be displayed on the external device by synthesizing the digital broadcasting data and the identification code.

4. The apparatus as claimed in claim 3, wherein the external device is a television or a monitor.

5. The apparatus as claimed in claim 1, further comprising a synthesis module for producing a video signal to be stored in the external device by synthesizing the digital broadcasting data and the identification code.

6. The apparatus as claimed in claim 5, further comprising a storing device for storing the video signal, the storing device being at least one of video tape recorder and an optical disc drive.

7. The apparatus as claimed in claim 1, wherein the code generator is a smart card and the identification code is a subscriber number stored in the smart card.

8. The apparatus as claimed in claim 1, wherein the code generator generates the identification code based on a mobile identification number.

9. The apparatus as claimed in claim 1, wherein the code generator generates the identification code based on a serial number of the digital broadcasting receiver.

10. The apparatus as claimed in claim 1, further comprising a key input part for setting a display mode to one of an internal display mode and an external display mode, the display mode being selected by a user, wherein the processor determines if the identification code is to be generated based on the display mode.

11. A method for preventing contents from being recorded by an external device in a digital broadcasting receiver capable of connecting with the external device, the method comprising the steps of:
determining a connection state with the external device;
synthesizing a video signal of received digital broadcasting with an identification code for identifying the digital broadcasting receiver if it is determined that the connection with the external device is achieved; and
outputting the synthetic signal to the external device.

12. The method as claimed in claim 11, further comprising a step of generating the identification code, if it is determined that there is a connection with the external device.

13. A method for preventing contents from being recorded by an external device in a digital broadcasting receiver capable of connecting with the external device, the method comprising the steps of:
determining whether an internal display mode is set or an external display mode is set;
synthesizing a video signal corresponding to received digital broadcasting with an identification code for identifying the digital broadcasting receiver, if it is determined that the external display mode is set; and
outputting the synthesized signal to the external device.

14. The method as claimed in claim 13, further comprising a step of generating the identification code, if it is determined that the external display mode is set.

15. The method as claimed in claim 13, further comprising a step of controlling the video signal corresponding to the received digital broadcasting to be output to a display module of the digital broadcasting receiver without being synthesized with the identification code, if it is determined that the internal display mode is set.
